(19) United States
(12) Patent Application Publication
(10) Pub. No.: US 2013/0148248 A1
(43) Pub. Date: Jun. 13, 2013

(54) POWER STRIP WITH HEAT PROTECTION FUNCTION

(71) Applicant: HAI-QING ZHOU, Shenzhen City (CN)

(72) Inventor: HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/340,642

(22) Filed: Dec. 29, 2011

(30) Foreign Application Priority Data
Dec. 12, 2011 (CN) 201110411728.X

(51) Int. Cl. H02H 5/04

(52) U.S. Cl. 361/103

(57) ABSTRACT

A power strip includes a plug, a main body, a thermo-sensor output unit, a comparison control unit, and a switch unit. The main body includes a number of electrical sockets. The thermo-senor output unit senses a temperature of the cable. When the sensed temperature is greater than a predetermined temperature, the thermo-sensor output unit outputs a voltage signal to the comparison control unit to make the comparison control unit turn off the switch unit to disconnect the plug from the sockets.

### BACKGROUND

1. Technical Field

The present disclosure relates to power strips, and particularly, to a power strip with heat protection function.

2. Description of Related Art

A power strip allows many outlets to supply alternating current (AC) voltages from a single AC power source. However, most power strip has no heat protection circuits. If the total current passing through the power strip is too great, heat of the power strip becomes excessive, the power strip may be damaged.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present disclosure. Moreover, in the drawings, all the views are schematic, and like reference numerals designate corresponding parts throughout the several views.

FIG. 1 is a schematic view of an exemplary embodiment of a power strip.

FIG. 2 is a block diagram of the power strip of FIG. 1.

FIG. 3 is a circuit diagram of a heat protection circuit of the power strip of FIG. 2.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

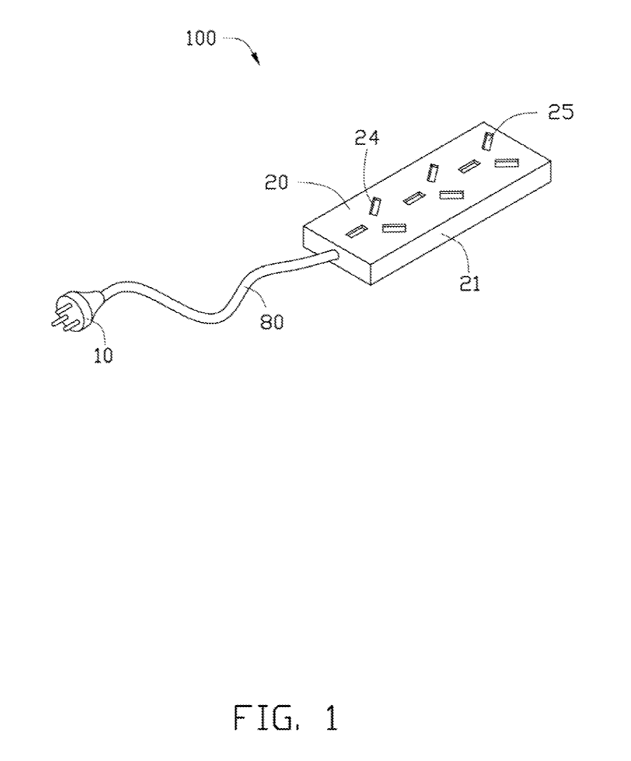

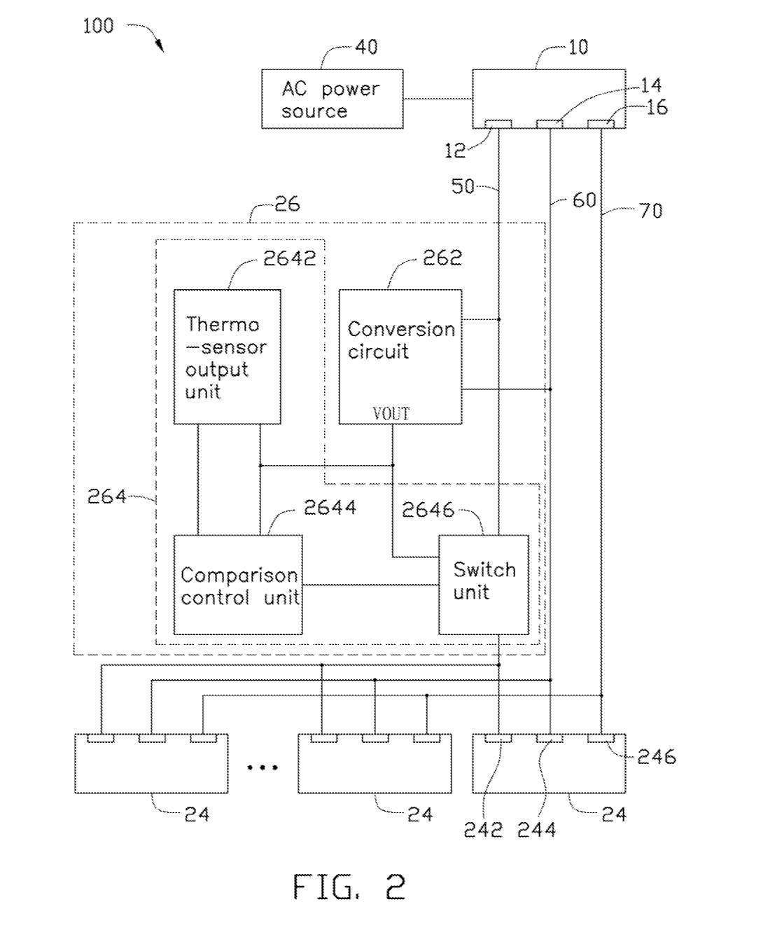

Referring to the FIGS. 1 and 2, an embodiment of a power strip 100 includes a plug 10, a main body 20, and a heat protection circuit 26. The plug 10 is inserted into an alternating current (AC) power source 40 to receive an AC voltage. The plug 10 includes a first hot pin 12, a first neutral pin 14, and a first ground pin 16.

The main body 20 includes an enclosure 21, and a plurality of sockets 24 mounted in the enclosure 21 and exposed through a plurality of outlets 25 defined in the top of the enclosure 21. Each socket 24 includes a second hot pin 242, a second neutral pin 244, and a second ground pin 246. The first hot pin 12 is connected to all the second hot pins 242 of all the sockets 24 through a first cable 50. The first neutral pin 14 is connected to all the second neutral pins 244 of all the sockets 24 through a second cable 60. The first ground pin 16 is connected to all the second ground pins 246 of all the sockets 24 through a third cable 70. The first to third cables 50-70 between the plug 10 and the main body 20 are wrapped by an insulating sleeve 80.

The heat protection circuit 26 includes a conversion circuit 262 and a control circuit 264. A first input terminal of the conversion circuit 262 is connected to the first cable 50. A second input terminal of the conversion 262 is connected to the second cable 60. The conversion circuit 262 receives the AC voltage from the plug 10 through the first and second cables 50 and 60, and converts the AC voltage into a direct current (DC) voltage and outputs the DC voltage through an output terminal VOUT of the conversion circuit 262.

The control circuit 264 includes a thermo-sensor output unit 2642, a comparison control unit 2644, and a switch unit 2646. The switch unit 2646 is connected to the first cable 50 between the conversion circuit 262 and the socket 24. The thermo-sensor output unit 2642, the comparison control unit 2644, and the switch unit 2642 are connected to the output terminal VOUT of the conversion circuit 262 to receive the DC voltage. The thermo-sensor output unit 2642 is mounted around the first to third cables 50-70 to sense a temperature of the first to third cables 50-70, and outputs a voltage corresponding to the sensed temperature to the comparison control unit 2644. The comparison control unit 2644 is connected to the thermo-sensor output unit 2642 to receive the voltage and compare the received voltage with a reference voltage. The comparison control unit 2644 is also connected to the switch unit 2646 to output a control signal to the switch unit 2646 to turn on or turn off the switch unit 2646 to control the basic connection between the plug 10 and the sockets 24. If the plug 10 is connected to the sockets 24, the sockets 24 work and output the AC voltages. If the plug 10 is disconnected from the sockets 24, the sockets 24 stop working and do not output any AC voltage.

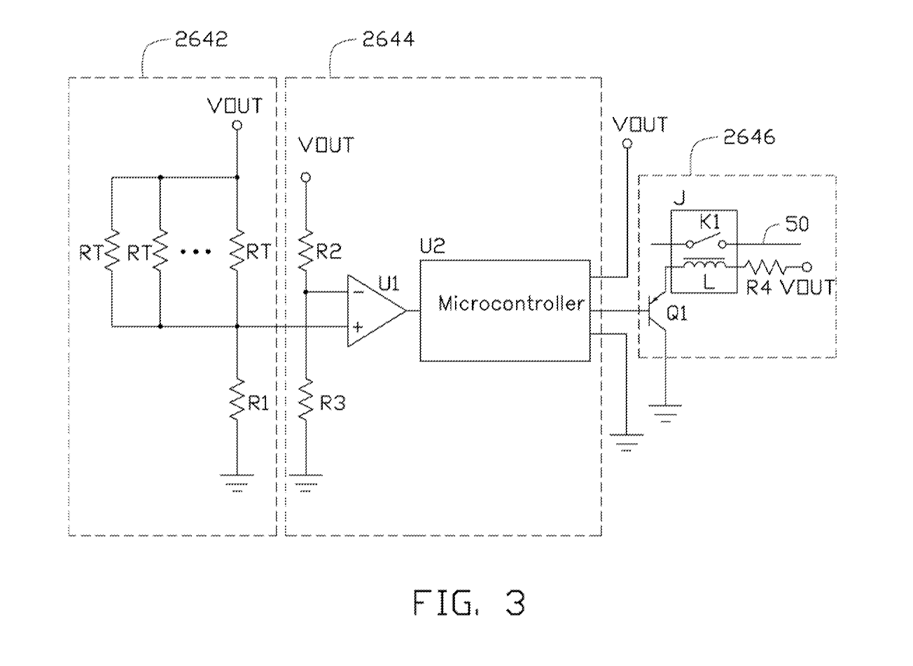

Referring to FIG. 3, the thermo-sensor output unit 2642 includes a plurality of thermo-sensors, such as thermistors RT, and a first resistor R1. The comparison control unit 2644 includes a comparator U1, a microcontroller U2, a second resistor R2, and a third resistor R3. The switch unit 2646 includes a transistor Q1, a relay J, and a fourth resistor R4. The relay J includes a coil L and a switch K1.

The thermistors RT are connected in parallel between the output terminal VOUT of the conversion circuit 262 and a non-inverting terminal of the comparator U1. The first resistor R1 is connected between the non-inverting terminal of the comparator U1 and ground. The second resistor R2 and the third resistor R3 are connected in series between the output terminal VOUT of the conversion circuit 262 and ground. An inverting terminal of the comparator U1 is connected to a node between the second resistor R2 and the third resistor R3 to receive the reference voltage. An output terminal of the comparator U1 is connected to the microcontroller U2. The microcontroller U2 is connected to a control terminal of the transistor Q1. A first terminal of the transistor Q1 is grounded. A second terminal of the transistor Q1 is connected to a first terminal of the coil L. A second terminal of the coil L is connected to the output terminal VOUT of the conversion circuit 262 through the fourth resistor R4. The switch K1 is mounted on the first cable 50 between the conversion circuit 262 and the sockets 24.

The thermistors RT are mounted in the insulating sleeve 80 and near the first to third cables 50-70. The thermistors RT sense the temperature of the first to third cables 50-70. The resistances of the thermistors RT change with changing temperature. In the embodiment, when the temperature increases, the resistances of the thermistors RT decrease. When the temperature decreases, the resistances of the thermistors RT increase.

When the temperature of the first to third cables 50-70 reaches a predetermined temperature, the sockets 24 are disconnected from the plug 10. When the temperature of the first to third cables 50-70 reaches the predetermined temperature, the resistances of the thermistors RT are taken as threshold values. According to the threshold resistance values and a resistance of the first resistor R1, the voltage at the non-inverting terminal of the comparator U1 which will correspond to the predetermined temperature can be determined. The second and third resistors R2 and R3 are selected so as to make the reference voltage of the inverting terminal of the comparator U1 equal to the voltage of the non-inverting terminal of the comparator U1 at the predetermined temperature.

In use, when the temperature of the first to third cables 50-70 is higher than the predetermined temperature, the resistances of the thermistors RT are lower than the threshold resistance. At that time, the variable voltage of the non-inverting terminal of the comparator U1 is greater than the reference voltage of the inverting terminal of the comparator U1. The output terminal of the comparator U1 thus outputs a resulting logic 1 (high level) signal to the microcontroller U2. The microcontroller U2 outputs a high level control signal to the control terminal of the transistor Q1. The transistor Q1 is turned off. There is no current passing through the coil L. The switch K1 is turned off. The plug 10 is disconnected from the sockets 24. Therefore, the sockets 24 stop working to protect the power strip 100.

When the temperature of the first to third cables 50-70 is lower than the predetermined temperature, the resistances of the thermistors RT are higher than the threshold resistance. At that time, the variable voltage of the non-inverting terminal of the comparator U1 is lower than the reference voltage of the inverting terminal of the comparator U1. For as long as that condition remains, the output terminal of the comparator U1 outputs a resulting logic 0 (low level) signal to the microcontroller U2. The microcontroller U2 outputs a low level control signal to the control terminal of the transistor Q1. The transistor Q1 is turned on. There is a current passing through the coil L. The switch K1 is turned on. The plug 10 is connected or reconnected to the sockets 24. Therefore, the sockets 24 will work normally and output the AC voltages.

The transistor Q1 is a pnp transistor. The control terminal, the first terminal, and the second terminal of the transistor Q1 are respectively the base, the collector, and the emitter of the pnp transistor. The first to fourth resistors R1-R4, the comparator U1, the microcontroller U2, and the transistor Q1 are received in the enclosure 21.

Although numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A power strip comprising:
a plug to be connected to an alternating current (AC) power source to receive an AC voltage;
a main body comprising a plurality of sockets connected to the plug through a cable to receive the AC voltage from the plug; and
a heat protection circuit comprising:
a conversion circuit connected to the plug to receive the AC voltage and convert the AC voltage into a direct current (DC) voltage, the conversion circuit comprising an output terminal to output the DC voltage; and
a control circuit comprising:
a switch unit connected to the cable between the conversion circuit and the sockets;
a thermo-sensor output unit to sense a temperature of the cable; and
a comparison control unit connected between the thermo-sensor output unit and the switch unit;
wherein when the sensed temperature of the cable is greater than a predetermined temperature, the thermo-sensor output unit outputs a first voltage to the comparison control unit, the comparison control unit outputs a first control signal to turn off the switch unit to disconnect the plug from the sockets.

2. The power strip of claim 1, wherein when the sensed temperature of the cable is lower than the predetermined temperature, the thermo-sense output unit outputs a second voltage to the comparison control unit, the comparison control unit outputs a second control signal to turn on the switch unit to connect the plug to the sockets.

3. The power strip of claim 1, wherein the thermo-sensor output unit comprises at least one thermistor and a first resistor, the at least one thermistor and the first resistor are connected in series between the output terminal of the conversion circuit and ground, a node between the at least one thermistor and the first resistor is connected to the comparison control unit, when the sensed temperature of the cable is greater than the predetermined temperature, the node between the at least one thermistor and the first resistor outputs the first voltage to the comparison control unit.

4. The power strip of claim 3, wherein the cable between the plug and the main body is covered by an insulated sleeve, the at least one thermistor is mounted in the insulated sleeve and near the cable to sense the temperature of the cable.

5. The power strip of claim 1, wherein the comparison control unit comprises a comparator, a first resistor, and a second resistor, the first resistor and the second resistor are connected in series between the output terminal of the conversion circuit and ground, a first input terminal of the comparator is connected to the thermo-sensor output unit to receive the first voltage, a second input terminal of the comparator is connected to a node between the first resistor and the second resistor to receive a reference voltage, when the sensed temperature of the cable is greater than a predetermined temperature, the thermo-sensor output unit outputs the first voltage to the first input terminal of the comparator, the comparator compares the first voltage with the reference voltage and outputs the first control signal to turn off the switch unit to disconnect the plug from the sockets.

6. The power strip of claim 5, wherein the comparison control unit further comprises a microcontroller, the microcontroller is connected between an output terminal of the comparator and the switch unit, when the sensed temperature of the cable is greater than the predetermined temperature, the thermo-sensor output unit outputs the first voltage to the first input terminal of the comparator, the comparator compares the first voltage with the reference voltage and outputs a comparison result to the microcontroller, the microcontroller outputs the control signal to turn off the switch unit to disconnect the plug from the sockets.

7. The power strip of claim 1, wherein the switch unit comprises a relay, the relay comprises a coil and a switch, a first terminal of the coil is connected to the comparison control unit, a second terminal of the coil is connected to the output terminal of the conversion circuit to receive the DC voltage, the switch is mounted on the cable, when the sensed temperature of the cable is greater than a predetermined temperature, the thermo-sensor output unit outputs the first voltage to the comparison control unit, the comparison control unit outputs the first control signal to turn off the switch to disconnect the plug from the sockets.

8. The power strip of claim 7, wherein the switch unit further comprises a transistor, a control terminal of the transistor is connected to the comparison control unit, a first terminal of the transistor is grounded, a second terminal of the transistor is connected to the first terminal of the coil, when the sensed temperature of the cable is greater than the predetermined temperature, the thermo-sensor output unit outputs the first voltage to the comparison control unit, the comparison control unit outputs the first control signal to the transistor, the transistor is turned off, the switch is turned off, the plug is disconnected from the sockets.

9. The power strip of claim 8, wherein the transistor is a pnp transistor, the control terminal, the first terminal, and the second terminal of the transistor are respectively a base, a collector, and an emitter of the pnp transistor.
